(19) United States
(12) Patent Application Publication
(10) Pub. No.: US 2010/0220848 A1
(43) Pub. Date: Sep. 2, 2010

(54) METHOD AND COMMUNICATION DEVICE FOR PROVIDING TELEPHONE CONFERENCES

(76) Inventor: Thomas Lederer, Herrsching (DE)

Correspondence Address: Buchanan Ingersoll & Rooney PC (SEN), 301 Grant Street, 20th Floor, Pittsburgh, PA, 15219, US

(21) Appl. No.: 12/677,902

(22) PCT Filed: Aug. 27, 2008
(86) PCT No.: PCT/EP08/61228

§ 371 Date: Mar. 12, 2010

(30) Foreign Application Priority Data
Sep. 18, 2007 (DE) 10 2007 044 408.9

(51) Int. Cl. H04M 3/42; G06F 12/00

(52) U.S. Cl. 379/202.01; 711/154; 711/E12.001

(57) ABSTRACT

The invention relates to a method for providing a telephone conference between a first communication device and at least one second communication device in a communication network, in which upon detection of a key being pressed on a second communication device to initiate a conference, the time of detection is taken as a basis for ascertaining dialup data stored in the communication network for the purpose of setting up a conference, the second communication device initiates an attempt at a connection to the first communication device, and the dialup data are taken as a basis for setting up a connection to implement the conference. The invention also relates to an arrangement for carrying out the method.

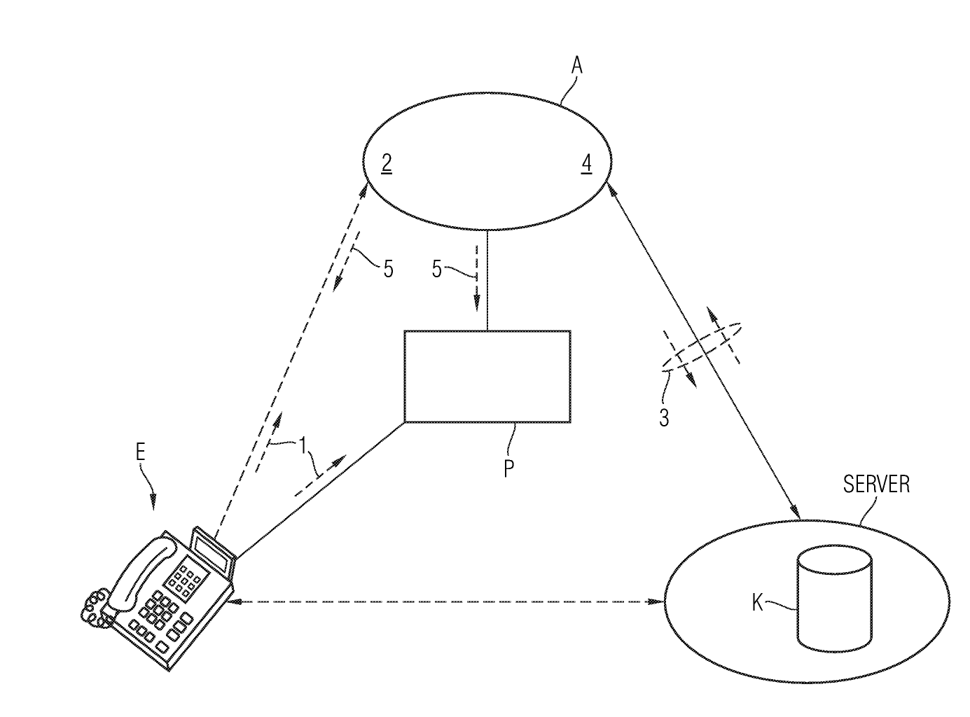

### CROSS-REFERENCE TO RELATED APPLICATIONS

This application is the United States national phase under 35 U.S.C. §371 of International Patent Application No. PCT/EP2008/061228, filed on Aug. 27, 2008, and claiming priority to German Application No. 10 2007 044 408.9 filed on Sep. 18, 2007. Both of those applications are incorporated by reference herein.

### BACKGROUND OF THE INVENTION

1. Field of the Invention

The invention relates to a method for providing telephone conferences as well as a communication device.

2. Background of the Art

Telephone conferences are known applications in telecommunication systems, which are frequently used particularly in a professional environment.

Starting with a certain number of participants, as a rule starting with four participating pieces of terminal equipment, a conference requires special hardware and software, such as conference bridges, for example, to which the participants dial in to form a telephone conference.

In this case, this bridge may be a workplace telephone or even a separate telephone in a conference room. As a result, it is frequently the case that the telephone number that must be dialed into changes from conference to conference. But because this number must be known in order for the conference to be set up, the current number is frequently sought after and input manually on the telephone, and in some circumstances it is often also necessary to know a dial-up code, which as a rule must be input in the suffix dialing.

### BRIEF SUMMARY OF THE INVENTION

Additional features and advantages of the invention are explained in greater detail starting from an exemplary embodiment of the invention depicted in the single FIGURE.

The FIGURE schematically depicts an exemplary embodiment of the method according to the invention. It shows a user terminal E, which may be a telephone, for example, and which along with the regular key configuration or keypad fields of standard telephones also has at least one keypad function or an additional key that initiates a conference. This key or function according to the invention, is characterized in that dialing in to set up a conference may be initiated using a call number ascertained from, e.g., an associated calendar at the time the key is pressed.

### BRIEF DESCRIPTION OF THE FIGURE

FIGURE A schematic representation of an exemplary embodiment of the method according to the invention.

### DETAILED DESCRIPTION OF THE INVENTION

In detail, the following steps are carried out in this process. After the key is pressed, this key press is transmitted at a first point in time 1 to a switching device P, which may be, e.g., a purely software-based switching device, a so-called softswitch or a hardware-based solution, such as a conventional switching center.

This then routes the information to an application A. Alternatively, the key press at the first point in time 1 may also be reported directly by the terminal E to the application A. Then, at a second point in time 2, the application A ascertains from an allocation table, an appointment calendar K, which is assigned to terminal E, and calls up the current appointment calendar entry for this point in time.

In a next step, at a fourth point in time 4, the application A then ascertains the dial-up information, e.g., the telephone number or a code required for it, or both, from the content of the entry and passes it on to the switching center via an interface, e.g., a CTI interface (CSTA) via the switching system P as an order to dial the call number as well as the suffix dialing of the code at a fifth point in time 5. Alternatively, this can also be transmitted directly to the terminal E so that the conference may be initiated.

The method according to the invention thus permits the dial-up call number to be ascertained automatically from an electronic appointment calendar, and this may be carried out, e.g., from the electronically transmitted invitation for a conference and may also be carried out according to the invention by access to an address book, e.g., with the use of the so-called Lightweight Directory Access Protocol (LDAP).

As a rule, the conference participant has made an entry available in the electronic appointment calendar, such as through the OUTLOOK® application or LOTUS NOTES® application and the conference room also has an assigned calendar.

According to the invention, the room is likewise invited to the conference, i.e., the invitation is found in the appointment calendar with an indication of the dial-up data in the event that the telephone conference is going to take place in the conference room.

The advantage of pressing the inventive “intelligent conference key,” so to speak, on the workplace telephone or on the telephone in the conference room is that now dial-up may be initiated using the call number ascertained from the associated calendar at the point in time of the key press.

Alternatively or additionally, if there is additional information such as the required code that must be transmitted to the conference bridge, this is indicated according to the invention on the display of the terminal or alternatively or additionally transmitted or input in suffix dialing, i.e., following the speed dialing entry.

A further alternative or additional embodiment (not shown) is that, according to the invention, an automatic, time-controlled pre-programming of the conference key according to the invention is carried out.

In other words, an application A ascertains the appointment book entries at regular intervals and programs the conference key of the terminal E.

Alternatively, the application A may also undertake this for several telephones according to a further development.

The advantages of automatically dialing into the telephone conference that is current at that point in time are ease of use as well as a time savings. Laboriously looking for the telephone conference call number is eliminated and the effort is reduced to a simple start by means of a key press.

In this case, the invention is not limited to conferences having at least three participants. In fact, it may also be used advantageously without further ado for conferences between two colleagues agreed upon by means of the cited calendar applications, i.e., a two-party conference, so to speak.

In the case of the method according to the invention for providing a telephone conference between a first communication device and at least one second communication device in a communication network, in which upon detection of a key being pressed on a second communication device to initiate a conference, the time of detection is taken as a basis for ascertaining dial-up data stored in the communication network for the purpose of setting up a conference, the second communication device initiates an attempt at a connection to the first communication device, and the dial-up data are taken as a basis for setting up a connection to implement the conference.

One potential advantage of an embodiment reported herein is that manually inputting dial-up data to set up a conference is no longer required, so the likelihood of input errors and the related failed connection attempts are minimized. Moreover, it is no longer necessary for the conference participants to search for the dial-up data.

The dial-up data are preferably ascertained in this process from at least one of the data memories available to the communication network, and the advantage of this is that the data can already have been saved in the data memory at an earlier point in time and be kept available.

In this case it is further advantageous for a memory device connected to the second communication device via an interface to be operated as the data memory. This makes it possible for information available from the second communication device regarding the dial-up data to be transmitted by means of the interface to the memory device so that, e.g., the user of the second communication device can have received the dial-up data at an earlier point in time, such as when he received the invitation to the conference, and at that time reserves these data via the second communication device on the memory device for the subsequent automatic set-up process.

It is also advantageous if, according to a further development, the data memory is operated by a computer communicating with the second communication device via the interface. It is hereby possible to directly extract, e.g., data transmitted to the user of the second communication device by means of electronic communication and save them via the interface device to the memory device or the data memory for subsequent use. In almost the same manner, this offers the possibility for expanded editing.

It is advantageous if the dial-up data are stored in the data memory organized in such a way that they are ascertained on the basis of information and/or a point in time reflecting the identity of the second communication device. This provides a simple but effective possibility of ascertaining the dial-up data that are valid at the time of detection.

This is preferably carried out as an allocation table.

Alternatively, it is also advantageous to operate a memory device integrated into the second communication device as a data memory. Thus, no additional equipment is needed, and an allocation to the second communication device is made just by this storage alone, so that only an analysis of the point in time when the key being pressed is detected is required to ascertain the correct dial-up data.

It is especially advantageous in the process if the storage is carried out on the basis of an application implementing a calendar function. This makes it possible, for example, to extract the allocation of the point in time and the planned conference from the calendar data in a simple manner. Moreover, the dial-up data may also be ascertained from calendar data, because, as a rule, an invitation for a conference will also contain the dial-up data as information.

Alternatively or additionally, it is also advantageous for the first communication device and/or the second communication device to communicate with the application via a switching center. This makes it possible for a centrally administered calendar function to be the basis for storage, so that the individual pieces of terminal equipment do not require any additional more extensive modification or adaptation in order to implement the method according to the invention.

As an alternative to this, it may also be advantageous for the first and/or second communication device to communicate directly with the application, wherein the application is preferably executed on the computer communicating with the second communication device via the interface. This makes it possible for conventional calendar or organizer functions that typically run on a user's own computer, such as the OUTLOOK® application or LOTUS NOTES® applications, to be used as the basis for storage.

As an alternative to this, the storage may also be based on user input of scheduling data. The advantage of this is that no further equipment besides the telecommunication terminal is required for the method according to the invention and it nevertheless has the advantage of automatically initiating the automatic dial-up for a conference taking place usually at a later point in time.

Alternatively or additionally, it is advantageous for the key to be programmed such that the dial-up data are obtained by the application at determined time intervals and stored such that they are assigned to the time of detection of the key. This guarantees quicker processing because, already at the point in time of detection, the dial-up data are merely read out of the memory defined for programming the key and can be used immediately. Moreover, it makes automatic updating and time-controlled pre-programming of the conference key possible.

It is preferably advantageous for the method according to the invention if the interface is operated as computer telephony integration (CTI), in particular according to the computer-supported telecommunications applications (CSTA) protocol, because this makes standardized communication possible between a telecommunication terminal and a computer device.

Furthermore, it is preferred that the data memory be accessed according to the Lightweight Directory Access Protocol (LDAP), which also supports the advantage of utilizing standardized and especially broader interfaces.

Moreover, it is advantageous if the dial-up data are formed in such a way that they contain the call number of the first communication device, wherein the dial-up data alternatively or additionally are formed in such a way that they contain a code required to set up the conference.

It is also advantageous for the code to be output on a display device of the second communication device. This makes allowances for the fact that there are systems which call to request the code and therefore automatic input of the code as part of suffix dialing is not easily possible, but must instead be accomplished manually.

1. A method for providing a telephone conference between a first communication device and a second communication device in a communication network, comprising:
a) detecting of a key being pressed on the second communication device to initiate a conference,
b) taking the time of detection as a basis for ascertaining dial-up data stored in the communication network for the purpose of setting up a conference,
c) initiating an attempt at a connection to the first communication device by the second communication device,
d) using the dial-up data as the basis for setting up a connection to implement the conference.

2. The method of claim 1, wherein the dial-up data is stored in data memories in the network and further comprising ascertaining the dial-up data from at least one of the data memories available to the communication network.

3. The method of claim 2, comprising operating as data memory a memory device connected to the second communication device via an interface.

4. The method of claim 3, comprising operating the data memory by a computer communicating with the second communication device via the interface.

5. The method of claim 4, comprising storing the dial-up data in the data memory organized in such a way that they are ascertained on the basis of information and/or a point in time reflecting the identity of the second communication device.

6. The method of claim 5, comprising storing the dial-up data in the data memory as an allocation table.

7. The method of claim 1, comprising operating a memory device integrated into the second communication device as the data memory.

8. The method of claim 1, comprising carrying out the storage on the basis of an application.

9. The method of claim 8, wherein at least one of the first communication device the second communication device communicates with the application via a switching center.

10. The method of claim 8, wherein at least one of the first communication device and the second communication device communicates directly with the application.

11. The method of claim 10, comprising executing the application on the computer communicating with the second communication device via the interface.

12. The method of claim 1, comprising carrying out the storage on the basis of a user input of scheduling data.

13. The method of claim 8, comprising programming the key such that the dial-up data are obtained by the application at determined time intervals and stored such that they are assigned to the time of detection of the key.

14. The method of claim 3, comprising operating the interface as computer telephony integration (CTI), according to the computer-supported telecommunications applications (CSTA) protocol.

15. The method of claim 1, comprising accessing the data memory according to the Lightweight Directory Access Protocol (LDAP).

16. The method of claim 1, comprising forming the dial-up data in such a way that the dial-up data contains the call number of the first communication device.

17. The method of claim 16, comprising forming the dial-up data in such a way that the dial-up data contains a code required to set up the conference.

18. The method of claim 17, comprising outputting the code on a display device of the second communication device.

19. A device for providing a telephone conference between a first communication device and at least one second communication device in a communication network, comprising:
a first communication device and a second communication device in a communication network;
at least one input on the second communication device, wherein actuation of said input initiates a conference, and wherein the time of detection correlates with dial-up data stored in the communication network, and wherein said dial-up data is the basis for setting up a connection to implement the conference.

20. The method of claim 8, wherein said application implements a calendar function.
